(19) United States
(12) Patent Application Publication
(10) Pub. No.: US 2026/0012925 A1
(43) Pub. Date: Jan. 8, 2026

(54) METHOD AND APPARATUS OF MOBILE-TERMINATED SMALL DATA TRANSMISSION (MT-SDT)

(71) Applicant: QUALCOMM Incorporated, San Diego, CA (US)

(72) Inventors: Shankar KRISHNAN, Poway, CA (US); Ozcan OZTURK, San Diego, CA (US); Ruiming ZHENG, Beijing (CN)

(21) Appl. No.: 18/873,592

(22) PCT Filed: Jul. 29, 2022
(86) PCT No.: PCT/CN2022/109053

§ 371 Date: Dec. 10, 2024

(51) Int. Cl. H04W 68/02; H04W 76/27

(52) U.S. Cl. CPC H04W 68/02; H04W 76/27

(57) ABSTRACT

A method of wireless communication at a network node and the related apparatus are provided. In the method, the network node first sends a paging message including a first indication of a mobile terminated small data transmission (MT-SDT) for a user equipment (UE) in a radio resource control (RRC) inactive state, and sends data for transfer to the UE while the UE remains in the RRC inactive state. By providing data transmission for UEs in Idle or inactive state, power consumption, latency and system overhead may beneficially be reduced.

### TECHNICAL FIELD

The present disclosure relates generally to communication systems, and more particularly, to wireless communication including mobile-terminated small data transmission (MT-SDT).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method of wireless communication at a network node, related computer-readable medium, and related apparatus are provided. The apparatus sends a paging message including a first indication of a mobile terminated small data transmission (MT-SDT) for a user equipment (UE) in a radio resource control (RRC) inactive state; and sends data for transfer to the UE while the UE remains in the RRC inactive state.

In an aspect of the disclosure, a method of wireless communication at a UE, related computer-readable medium, and related apparatus are provided. The apparatus receives a paging message from a network node, the paging message including a first indication of an MT-SDT for the UE while the UE is in an RRC inactive state. The apparatus transmits a message to the network node including a second indication for the MT-SDT and receives downlink data from the network node while the UE remains in the RRC inactive state.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station (BS) and a user equipment (UE) in an access network.

FIG. 4 is a call flow diagram illustrating the MT-SDT indication process through paging in accordance with various aspects of the present disclosure.

FIG. 5 is a call flow diagram illustrating the MT-SDT indication process by UE in accordance with various aspects of the present disclosure.

FIG. 6 is a call flow diagram illustrating the NG-RAN determination process for paging UE for MT-SDT in accordance with various aspects of the present disclosure.

FIGS. 7A and 7B are call flow diagrams illustrating the MT-SDT with dual connectivity in accordance with various aspects of the present disclosure.

FIG. 8 is a call flow diagram illustrating the MT-SDT indication process through Retrieve UE Context Request in accordance with various aspects of the present disclosure.

FIGS. 9, 10, 11, and 12 are flowcharts illustrating methods of wireless communication in accordance with various aspects of the present disclosure.

FIGS. 13, 14, and 15 are diagrams illustrating hardware implementations of the system of MT-SDT in accordance with various aspects of the present disclosure.

### DETAILED DESCRIPTION

A network may have data to transmit to a UE that is in an RRC inactive state.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

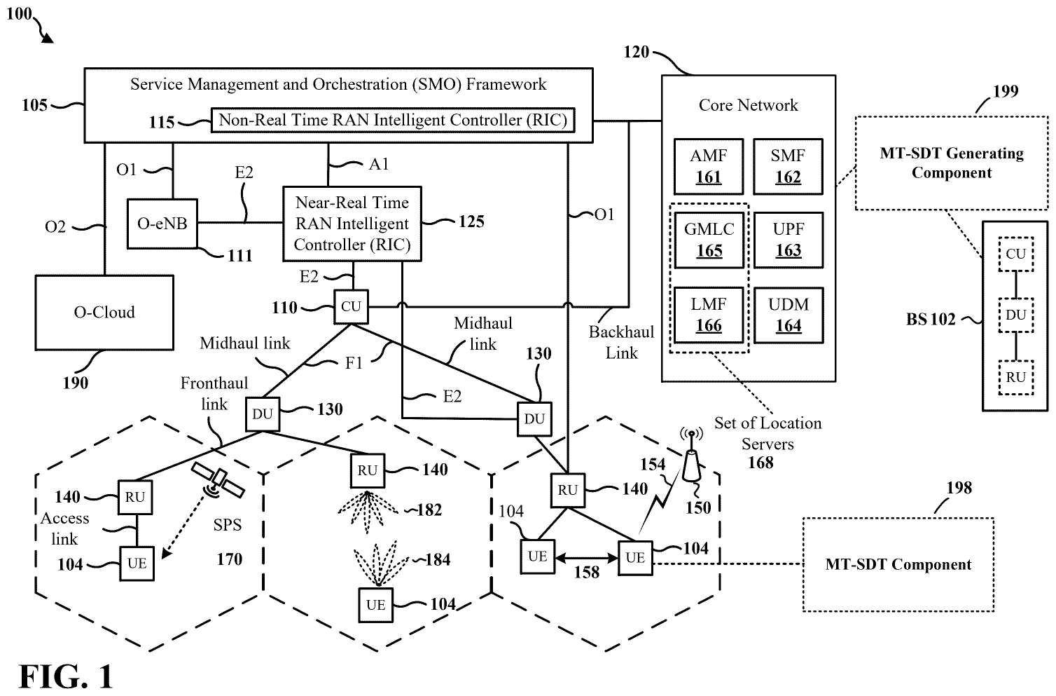

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Centralized Unit-User Plane (CU-UP)), control plane functionality (i.e., Centralized Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to include an MT-SDT component 198 that is configured to receive a paging message from a network node, the paging message including a first indication of an MT-SDT for the UE while the UE is in an RRC inactive state, transmit a message to the network node including a second indication for the MT-SDT, and receive downlink data from the network node while the UE remains in the RRC inactive state. In certain aspects, the base station 102 may be configured to include an MT-SDT generating component 199 configured to send a paging message including a first indication of an MT-SDT for a UE in an RRC inactive state; and send data for transfer to the UE while the UE remains in the RRC inactive state. Although the following description may be focused on 5G NR, the concepts described herein may be applicable to other similar areas, such as LTE, LTE-A, CDMA, GSM, and other wireless technologies.

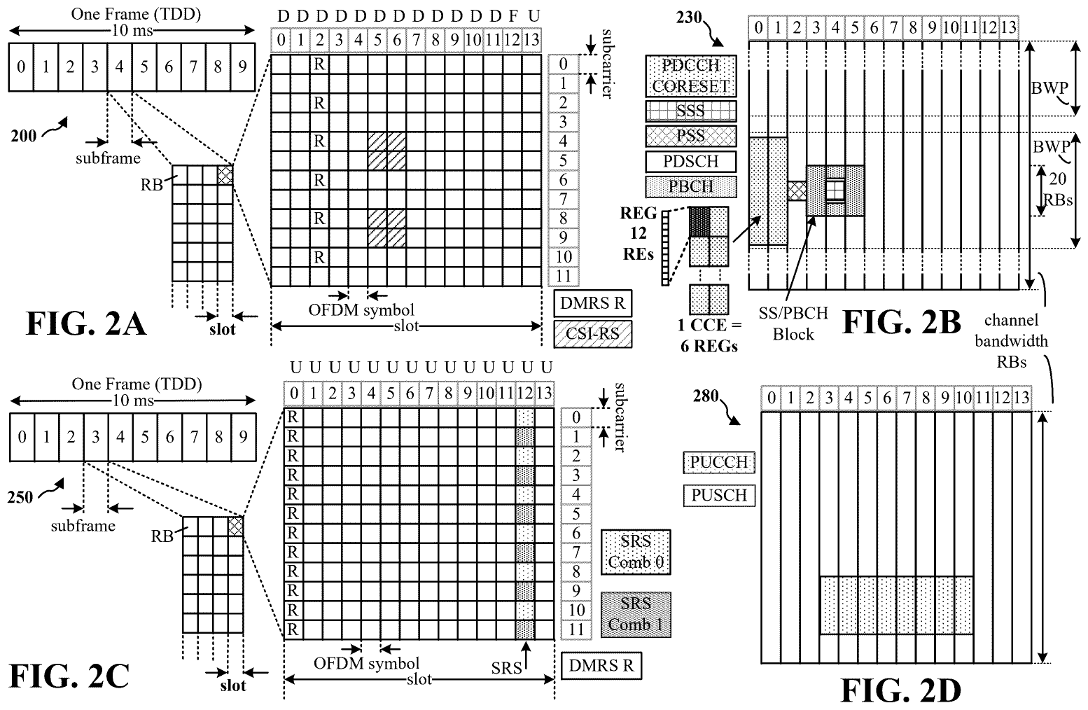

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

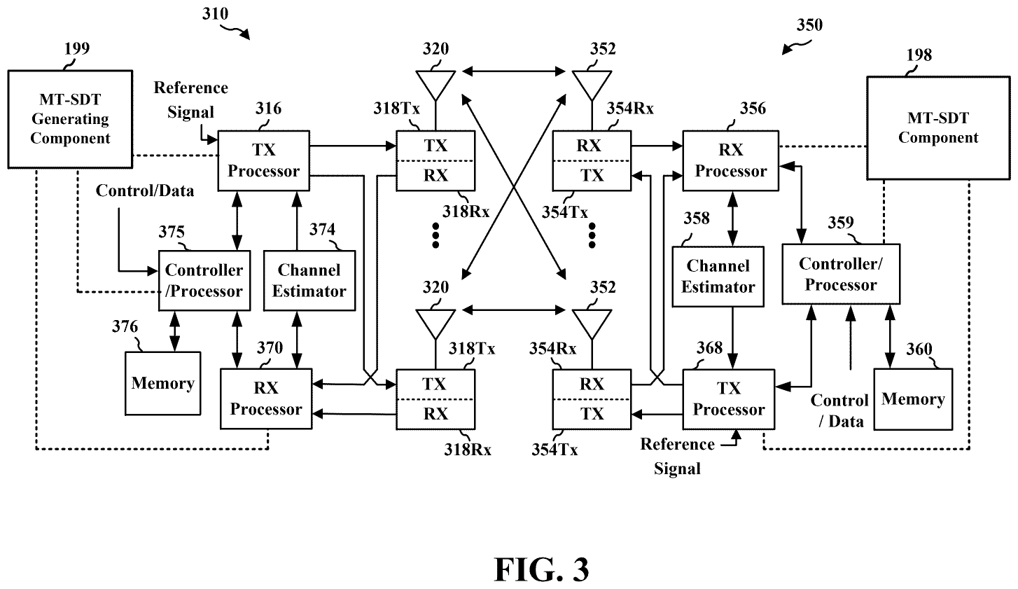

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the MT-SDT component 198 of FIG. 1.

At least one of the TX processor 316, the RX processor 370, and the controller/processor 375 may be configured to perform aspects in connection with the MT-SDT generating component 199 of FIG. 1.

When the UE is in an RRC idle state or an RRC inactive state, in order to transmit a data transmission, the UE may perform a full RRC connection establishment procedure. The RRC connection establishment procedure for idle user UEs may include a random access (RA) procedure. The RA procedure may be used to initiate a data transfer but may have a large overhead cost in comparison to a size of the data to be transmitted. As well, the RA procedure may add latency to the communication between the UE and the network. as an example, the RA procedure may include a sequence of messages including a Msg1 (physical random access channel PRACH preamble), a Msg2 (random access request (RAR)), a Msg3 (RRC Connection Request, RRC Connection Re-establishment Request, RRC Connection Resume Request or the like depending on the reason for RA procedure), a Msg4 (early contention resolution, RRC Connection Setup etc.), and a Msg5 which can be used for the UL data (unless SR/BSR is required before actual payload transmission). This involves five or more messages for UL data before actual payload transmission. This is a large overhead for applications that transmit uplink data that fits into one transport block size (TBS).

After the RA procedure is completed, a UL transmission may be performed. Such an approach may include perform a number of message exchanges before the actual payload transmission of the data occurs, even for very small and/or infrequent payload.

When the data amount to be transmitted is small (e.g., below a size threshold) (the transmission may be referred to as small data transmission (SDT)), the access network may allow a UE to transmit uplink small data while remaining in the RRC inactive state, and the UE does not need to move to an RRC connected state to transmit the uplink data. As an example, random access based SDT (i.e., RA-SDT) may enable the UE to transmit UL data through a 2-step or a 4-step RACH procedure, while the UE remains in the RRC inactive state. As another example, configured grant based SDT (i.e., CG-SDT) may include a network configuring PUSCH resources (e.g., semi-static resources for uplink transmission) (e.g., reusing the configured grant type 1), and the UE may use the previously configured resources to transmit small data when it becomes arrives for transmission and without transitioning to an RRC connected state. Additionally, after an initial SDT, the UE may continue subsequent transmission/reception of small data in UL and DL without transitioning to an RRC connected state, and the state transition decisions may be controlled by a network entity. A non-access stratum (NAS) message delivery within SDT may be enabled by configuring SRB1 and SRB2 for SDT in the RRC inactive state (the NAS message is transferred via SRB2).

Aspects of the present disclosure provide for paging-triggered SDT to UEs while the UEs remain in the RRC inactive state. Rather than scheduling the first data transmission in Msg 5 or later, as in conventional techniques, the data transmission in the UL may transit data (e.g., payload) in Msg1 or Msg3, for example. By providing data transmission for UEs in an RRC idle or RRC inactive state, power consumption, latency and system overhead may be reduced.

The disclosure presents the enhancements for various aspects of MT-SDT, including, but not limited to, MT-SDT indication through paging, MT-SDT indication by UE, the RAN determination process on whether to page UE for MT-SDT, MT-SDT with dual connectivity, MT-SDT indication in Retrieve UE Context Request, and the combination of MT-SDT and mobile originated small data transmission (MO-SDT). The enhanced aspects are applicable to MT-SDT support RA-SDT and CG-SDT as the UL response, and/or support MT-SDT procedure for initial DL data reception and subsequent UL/DL data transmission in the RRC inactive state.

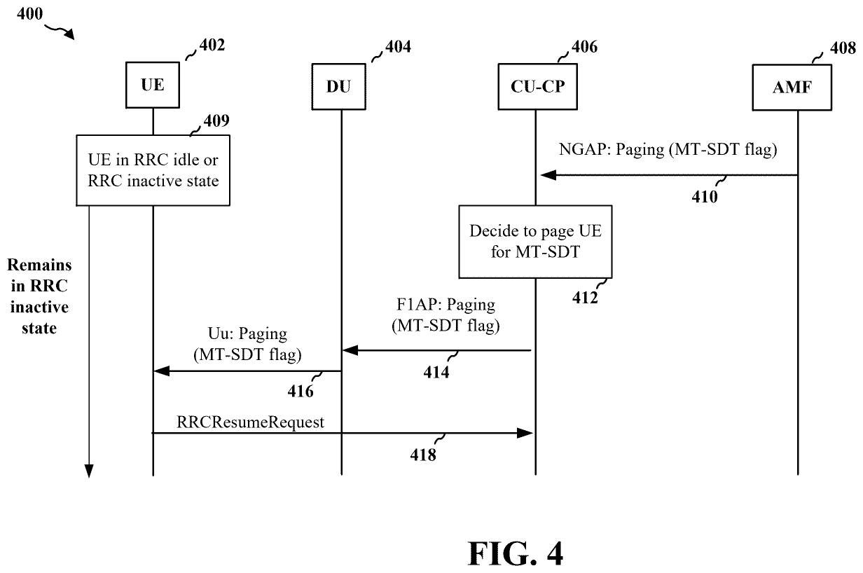

FIG. 4 is a call flow diagram 400 illustrating the MT-SDT indication process through paging in accordance with various aspects of the present disclosure. The UE 402 may be in an RRC idle or RRC inactive state, e.g., as shown at 409. As shown in FIG. 4, in one configuration, a CU-CP 406 may include an MT-SDT flag (e.g., an indication of MT-SDT) in an F1 application protocol (F1AP) message 414 between the CU-CP 406 and a DU 404 as an indication that a paging message for a UE is for MT-SDT. The DU 404 may include the MT-SDT flag in a Uu paging message 416 between the DU 404 and a UE 402. The network may include an access and mobility management function (AMF) 408. In one configuration, if the UE in an RRC idle or RRC inactive mode is being paged by the network for MT-SDT (e.g., that the network has data to be transmitted to the UE in an MT-SDT), the AMF 408 may include the MT-SDT flag in an NG application protocol (NGAP) message 410 between the AMF 408 and the CU-CP 406, and the NGAP message may inform the CU-CP 406 that the paging of the UE in the RRC idle or RRC inactive state is for the MT-SDT. The CU-CP 406 may determine, at 412, to page the UE 402 for MT-SDT. In response to the Uu paging message 416, the UE may respond by transmitting an RRC resume request message 418 indicating that the UE is ready to receive the MT-SDT.

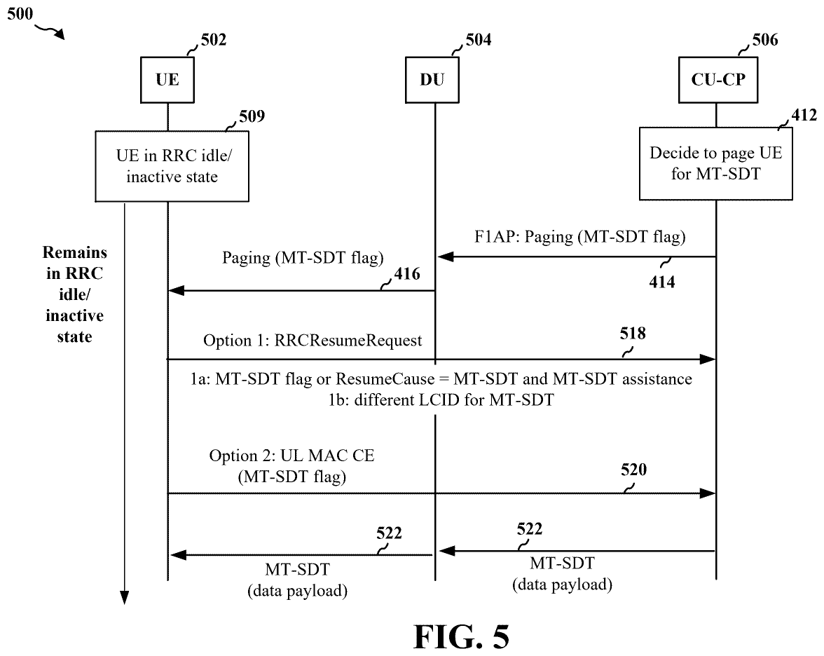

FIG. 5 is a call flow diagram 500 illustrating the MT-SDT indication by a UE in accordance with various aspects of the present disclosure. The UE 502 may be in an RRC idle or RRC inactive state, e.g., as shown at 509. In some aspects, the indication from the UE 502 may be sent in response to the Uu paging message 416 described in connection with FIG. 4, and the same reference numbers have been used for such aspects as in FIG. 4. As shown in FIG. 5, various aspects may be used for the UE to indicate that it is ready to receive the MT-SDT. In one configuration, the MT-SDT indication may be provided by the UE 502 through an RRC Resume Request 518. The RRC Resume Request 518 transmitted by the UE 502 may indicate that the RRC resume request is to receive MT-SDT from the network. In some aspects, the UE 502 may include an MT-SDT flag (e.g., an indication) that indicates that the resume request is for MT-SDT or may indicate a resume cause that is dedicated for MT-SDT in the RRC Resume Request. The resume cause may indicate the purpose of the RRC resume request 518 is for MT-SDT reception. In some aspects, the UE may include MT-SDT assistance information in the RRC resume request 518. In some aspects, rather than including a flag, cause, or other indication in the RRC resume request 518 that indicates the request is for MT-SDT, the UE 502 may a particular different logical channel ID (LCID) for transmitting the RRC Resume Request when the request is for ongoing SDT that is due to mobile terminated data. In such an example, the LCID used for the RRC resume request may indicate the purpose of the request as being for MT-SDT. In some aspects, the UE 502 may include an MT-SDT flag in an uplink medium access control-control element (MAC-CE) 520 that the UE 502 transmits to the network in response to the paging message 416. The UE 502 may transmit the RRC Resume Request 518 or the UL MAC-CE 520 to the CU-CP 506. The network may then respond by transmitting the MT-SDT to the UE 502, at 522, while the UE remains in the RRC inactive state and without resuming an RRC connection with the UE.

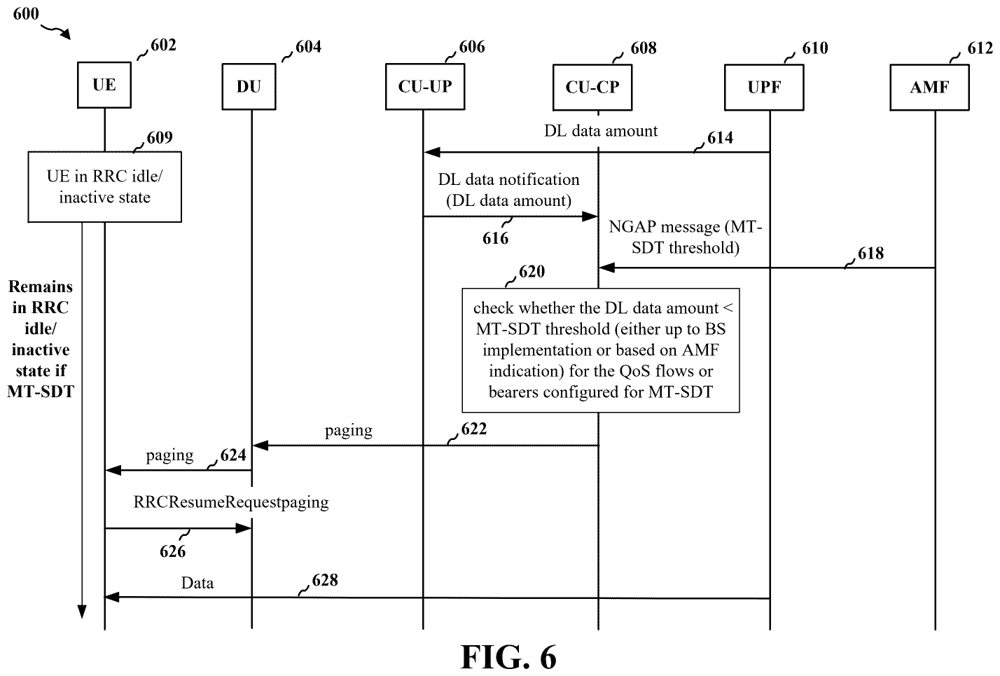

FIG. 6 is a call flow diagram 600 illustrating a RAN determination process for paging a UE for MT-SDT in accordance with various aspects of the present disclosure. The UE 602 may be in an RRC idle or RRC inactive state, e.g., as shown at 609. As shown in FIG. 6, in the RAN determination process, a User Plane Function (UPF) 610 may send a DL data amount 614 to the CU-UP 606 indicating an amount of data to be sent to the UE. The DL data amount 614 may be in bits (e.g., indicating a number of bits of data to be transmitted to the UE by the network), and may be sent to the CU-UP 606 over an N3 interface. Upon receiving the DL data amount 614 from the UPF 610, the CU-CP 606 may inform the CU-CP 608 about the DL data amount, at 616. In some aspects, the CU-UP 606 may provide the information about the amount of data to be provided to the UE in an E1 application protocol (E1AP) message (e.g., DL DATA NOTIFICATION) or a new E1AP message. The CU-CP 608 may then determine whether to page the UE for MD-SDT or to page the UE for a non-MD-SDT data transfer. The determination may correspond to 412 in FIG. 4, for example. The Cu-CP 608 may make the determination based on a comparison of the amount of data to be transmitted to the UE and am MT-SDT threshold. In some aspects, the AMF 612 may indicate an MT-SDT threshold to the NG-RAN via an NG application protocol (NGAP) message 618 (e.g., INITIAL UE CONTEXT SETUP REQUEST) or a new NGAP message. The MT-SDT threshold may be in bits (e.g., indicating a threshold number of bits that can be sent to the UE in an MT-SDT), and may assist the CU-CP 608 in determining whether to page the UE 602 for MT-SDT. For example, the CU-CP 608 may check, at 620, whether the DL data amount is less than the MT-SDT threshold for the quality of service (QoS) flows or bearers configured for MT-SDT. If the amount of data is less than the MT-SDT, the CU-CP may page 622 the UE 602 for MT-SDT, e.g., as described in connection with FIGS. 4 and/or 5. If the amount of data is more than the MT-SDT threshold, at 622, the CU-CP 608 may send a page to the UE 602 for a non-SDT data transmission. The DU 604 may transmit the corresponding page 624 (e.g., whether for MT-SDT or not according to the determination, at 620), and the UE 602 may respond by transmitting an RRC resume request 626 for MT-SDT or for a non-SDT transfer based on the page 624. The network may then transmit the data 628 to the UE 602. If the CU-CP 608 determines, at 620, to transmit the data 628 in a MT-SDT, the UE 602 may receive the data while remaining in the RRC inactive state. The DL data amount and the MT-SDT threshold may be provided at different granularities at, for example, a protocol data unit (PDU) session, a QoS flow, or a data radio bearer (DRB). For example, the AMF 612 may provide one or more MT-SDT thresholds to the CU-CP 608, and each threshold may be for one or more particular PDU sessions, one or more QoS flows, or one or more DRBs.

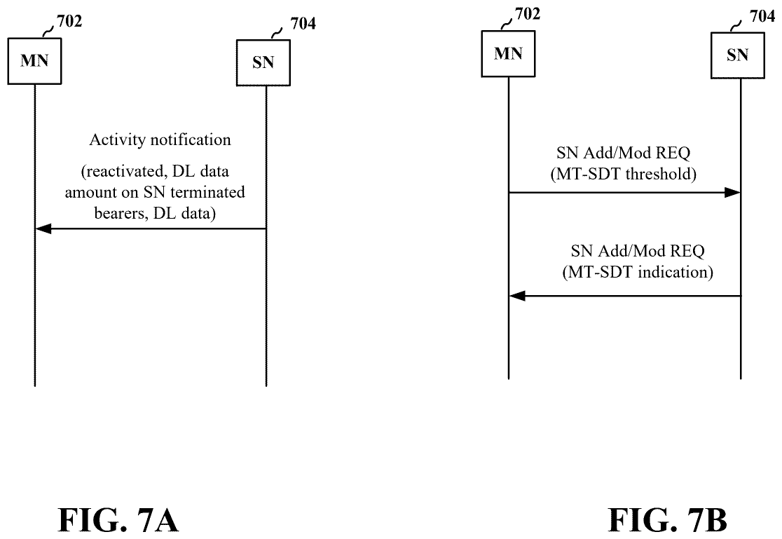

FIGS. 7A and 7B are call flow diagrams illustrating the MT-SDT with dual connectivity in accordance with various aspects of the present disclosure. In a dual connectivity, a UE, e.g., such as the UE described in connection with any of FIGS. 4-6, may have a first connection with a first network node, e.g., a first base station, and a second connection with a second network node, e.g., a second base station. In some aspects, the two network nodes may be for different radio access technologies, such as LTE and NR. One network node may be a primary node, which may be referred to as a master node in some aspects. The other node may be a secondary node. The UE may be in an RRC idle or RRC inactive state for the primary node and the secondary node. In some aspects, the secondary node may have data to transfer to the UE. FIGS. 7A and 7B illustrate example aspects of a determination at the primary node or the secondary node about whether the data is to be transferred to the UE as an MT-SDT. As shown in FIG. 7A, the network node may be a primary node 702 for dual connectivity with the UE, and the primary node 702 may determine whether to page the UE for MT-SDT. In some aspects, the primary node 702 may receive an activity notification from a secondary node 704 for the UE. The activity notification may indicate the DL data amount that the secondary node has for transmission to the UE on one or more secondary node terminated bearers. The secondary node 704 may indicate the amount of DL data to the primary node 702 in an existing Xn message (e.g., ACTIVITY NOTIFICATION) or a new Xn message. In some aspects, for secondary node terminated master cell group (MCG) bearers, the secondary node may just forward the DL data, and the primary node may decide whether to page the UE for MT-SDT based on the DL data.

As shown in FIG. 7B, in another example, the network node may be an secondary node 704 for dual connectivity with the UE, and the secondary node 704 may determine whether to page the UE for MT-SDT, e.g., rather than providing information to the primary node in order to enable the primary node to make the determination, as occurs in FIG. 7A. In this example, the primary node 702 may indicate the MT-SDT threshold to the secondary node. In some aspects, the primary node 702 may indicate an addition/modification of one or more MT-SDT thresholds, and the secondary node 704 may decide whether the amount of data to be transmitted to the UE is less than the threshold. The secondary node 704 may inform the primary node 702 to perform MT-SDT, e.g., if the amount of data is below or equal to the size threshold for MT-SDT. If the amount of data is more than the threshold, the secondary node 704 may indicate to the primary node to page the UE without indicating MT-SDT. As described in connection with FIG. 6, the MT-SDT threshold(s) may be applicable for one or more QoS flows, one or more DRBs, one or more PDU sessions, etc. The primary node 702 may inform the secondary node 704 about the QoS flows or bearers for which the MT-SDT threshold is applicable.

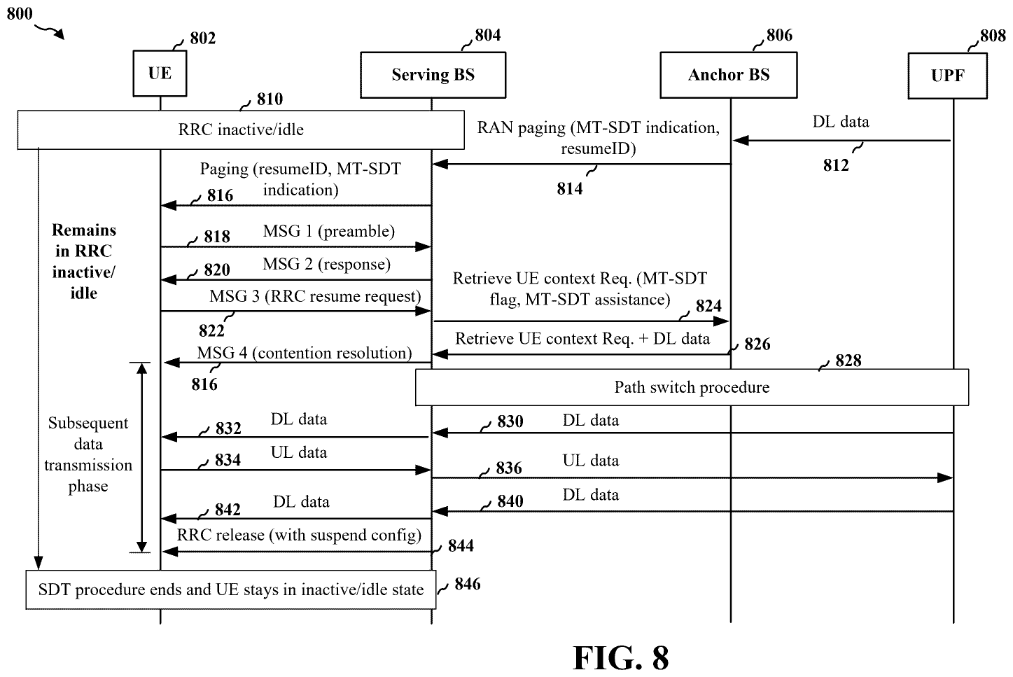

FIG. 8 is a call flow diagram 800 illustrating aspects in which the MT-SDT indication may be provided in a UE context retrieval request in accordance with various aspects of the present disclosure. As shown in FIG. 8, the network may include an anchor node 806 (e.g., an anchor base station) and a serving node 804 (e.g., a serving base station). The UE 802 may be in an RRC idle or RRC inactive state, at 810. The UPF 808 may indicate, at 812, to the anchor base node 806 that there is downlink data for the UE 802. The anchor node 806 may send a paging message 814 to the serving node 804. The paging message 814 may include an MT-SDT indication, or a resume ID that indicates that the data is to be sent to the UE as a MT-SDT. The serving node 804 may page the UE 802 for MT-SDT, at 816.

As shown in FIG. 8, the UPF 808, the anchor node 806, the serving node 804 may first transmit to the UE 802 information related to the MT-SDT, such as the DL data and one or more indications for MT-SDT. The UE 802 may send an RRC Resume Request to the serving node 804. Details of these procedures are similar to those present in FIG. 6, and therefore are omitted here for the sake of conciseness. For example, the page 816 may include any of the aspects described in connection with FIG. 4 or 5, for example. As illustrated at 816, the page 816 may include a resume ID or an indication that indicates to the UE that the page is for MT-SDT. The UE 802 may respond by sending a random access Msg 1 818, and the serving node 804 may respond with a Msg 2 response 820. The UE 802 may transmit a Msg 3 with an RRC resume request to receive the MT-SDT. The resume request may indicate that the request is for MT-SDT, e.g., as described in connection with FIG. 5.

Upon receiving the RRC Resume Request from the UE 802, the serving node 804 may include the MT-SDT flag and, if there is any, MT-SDT assistance information, in Retrieve UE Context Request message 824 to the anchor node 806. Upon receiving the message from the serving node 804, the anchor node 806 may identify that this is an MT-SDT based on the MT-SDT flag and the MT-SDT assistance information, and may send the DL data to the serving node 804 in the Retrieve UE Context Response message 826. Alternatively, the anchor node 806 may send the DL data to the serving node 804 in a later step.

As further illustrated in FIG. 8, the serving node 804 may transmit a Msg 4 816 to the UE 802. A path switch procedure may be performed, at 828, to switch the path to the serving node 804. The UPF 808 may then provide the data for the MT-SDT to the serving node 804, at 830. The serving node 804 may then transmit the DL data 832 to the UE 802 in an MT-SDT. In some aspects, the UE may proceed to transmit UL data 834 (e.g., provided to the UPF at 836) following reception of the DL data 832 as an MO-SDT. In some aspects, the UE 802 may receive further DL data 842 as an MT-SDT from the UPF (at 840) via the serving node 804. As illustrated at 844, the serving node 804 may send an RRC release to the UE. As shown at 846, the UE 802 may remain in the inactive state throughout the MT-SDT and/or MO-SDT transfer.

In some aspects, a UE may indicate that the UE has MO-SDT for transmission to the network through the use of a particular RACH resource for the SDT. For example, the UE may not transmit a flag specific information to the network in an RRC resume request for MO-SDT, and may instead transmit the RRC resume request using a RACH resource that is dedicated for SDT. The resource on which the network receives the request indicates to the network that the request is for MO-SDT rather than to resume an RRC connection. As described in connection with FIG. 8, in some aspects, the criteria (e.g., both the DL data and the UL being less than or equal to a size threshold) for both MT-SDT and MO-SDT may be met, and it may improve efficiency for the UE to indicate the MO-SDT in the same RRC resume request that indicates the UE is ready to receive the MT-SDT.

In some aspects, the UE may include a flag for MT-SDT and for MO-SDT (e.g., which may include an indication of MT-SDT and a separate indication for MO-SDT, or which may include a single indication that indicates both MT-SDT and MO-SDT in the RRC resume request 822. In some aspects, the indication may include a resume cause that is dedicated for MO-SDT and MT-SDT. In some aspects, the indication(s) or the resume cause may indicate that an ongoing SDT is due to both mobile originated data (e.g., MO-SDT) and mobile terminated data (e.g., MT-SDT).

Upon receiving the MT-SDT+MO-SDT flag/indication in RRC resume request, the serving node may include this flag in UE context retrieval request message 824 so that the anchor node knows this is an MT-SDT and MO-SDT and may plan the subsequent data transfer accordingly.

Alternatively, the UE may provide an MT-SDT indication/resume cause in the RRC resume request 822 and may use the dedicated RACH resources for MO-SDT to transmit the RRC resume request 822 in order to indicate to the network that the request is for both MO-SDT and MT-SDT.

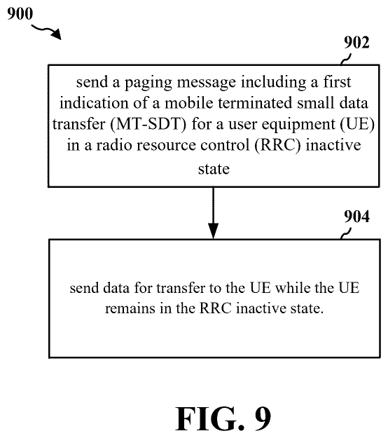

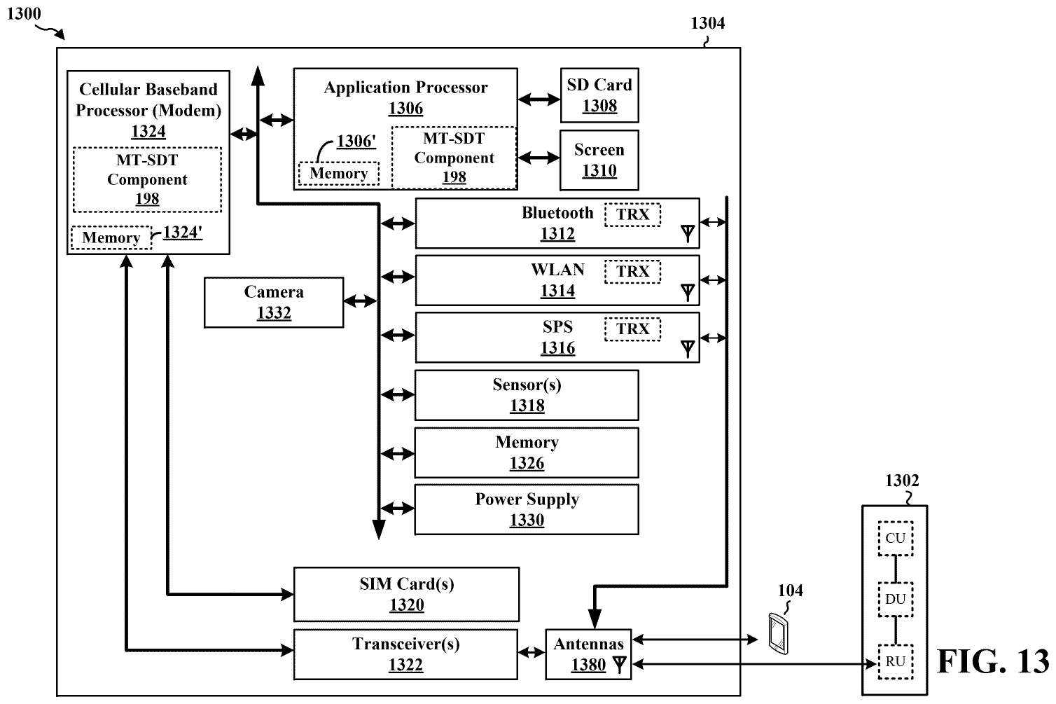

FIG. 9 is a flowchart 900 illustrating methods of wireless communication in accordance with various aspects of the present disclosure. The methods may be performed by a network node for MT-SDT. The network node may be a base station, or a component of a base station, in the access network of FIG. 1 or a core network component (e.g., base station 102, 310; CU 110; DU 130, 404, 504, 604; RU 140; CU-CP 406, 506 608; CU-UP 606; AMF 408 612; UPF 610; primary node 702; secondary node 704; anchor node 806; serving node 804; or the network entity 1302 in the hardware implementation of FIG. 13). The method provides signaling that helps to enable MT-SDT, which may improve the efficiency with which data may be transferred from a network to a UE in an RRC idle or RRC inactive state.

As shown in FIG. 9, at 902, the network node may send a paging message including a first indication of a MT-SDT for a UE in an RRC idle or RRC inactive state. The UE may be the UE 104, 350, 402, 502, 602, 802, or the apparatus 1304 in the hardware implementation of FIG. 13. For example, 902 may be performed by the MT-SDT generating component 199. FIGS. 4-8 illustrate various aspects of a network node providing a paging message including an indication of an MT-SDT. As shown in FIG. 4, in one configuration, the network node may include a centralized unit control plane (CU-CP) 406 and the paging message including the first indication of the MT-SDT may be included in the F1 application protocol (F1AP) message between the CU-CP 406 and the distributed unit (DU) 404. In one configuration, the network node may include the DU 404 and the paging message including the first indication of the MT-SDT may be included in the Uu paging message between the DU 404 and the UE 402. In one configuration, the network node may include an access and mobility management function (AMF) 408 and the paging message including the first indication of the MT-SDT may be included in an NG application protocol (NGAP) message between the AMF 408 and the CU-CP 406.

At 904, the network node may send data for transfer to the UE while the UE remains in the RRC idle or RRC inactive state. For example, 904 may be performed by the MT-SDT generating component 199.

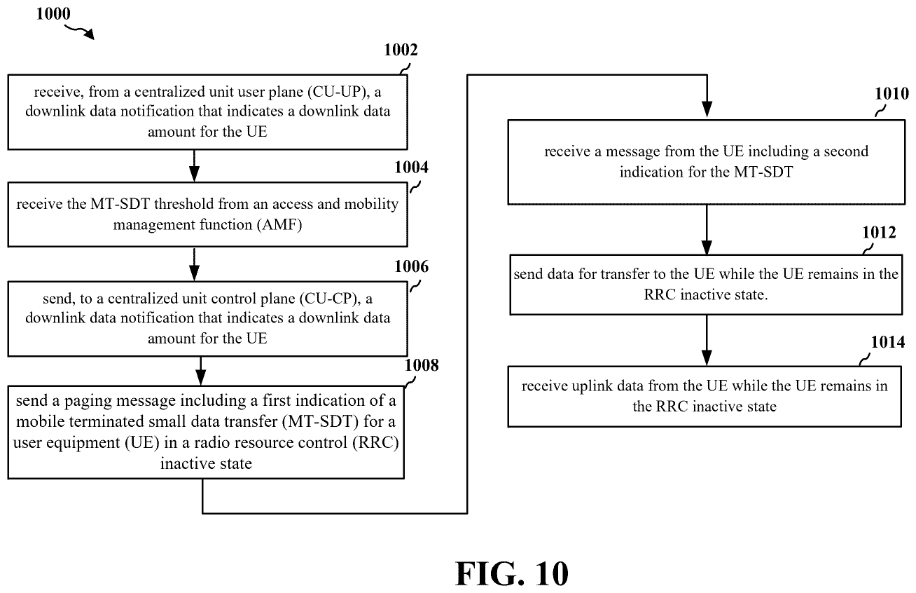

FIG. 10 is flowchart 1000 of methods of wireless communication in accordance with various aspects of the present disclosure. The method may be performed by a network node for MT-SDT. The network node may be a base station, or a component of a base station, in the access network of FIG. 1 or a core network component (e.g., base station 102, 310; CU 110; DU 130, 404, 504, 604; RU 140; CU-CP 406, 506 608; CU-UP 606; AMF 408 612; UPF 610; primary node 702; secondary node 704; anchor node 806; serving node 804; or the network entity 1302 in the hardware implementation of FIG. 13). The method provides signaling that helps to enable MT-SDT, which may improve the efficiency with which data may be transferred from a network to a UE in an RRC idle or RRC inactive state.

As shown in FIG. 10, at 1008, the network node may send a paging message including a first indication of a mobile terminated small data transfer (MT-SDT) for a user equipment (UE) in a radio resource control (RRC) inactive state. At 1010, the network node may receive a message from the UE including a second indication for the MT-SDT. At 1012, the network node may send data for transfer to the UE while the UE remains in the RRC idle or RRC inactive state, and the data may be transmitted to the UE in response to the message including the second indication. The paging message may be sent, e.g., by the MT-SDT generating component 199.

As shown in FIG. 5, in one configuration, the second indication may include one or more of: an MT-SDT flag, a resume cause that indicates the MT-SDT, MT-SDT assistance information, or a logical channel ID associated with the MT-SDT. In one configuration, the message from the UE may include an RRC resume request message. Alternatively, in another configuration, the message from the UE comprises an uplink MAC-CE.

As shown FIG. 10, in some aspects, the method of MT-SDT may further include step 1014. At 1014, the network node may receive uplink data from the UE while the UE remains in the RRC idle or RRC inactive state. The reception may be performed, e.g., by the MT-SDT generating component 199. The uplink data from the UE may be transmitted as MO-SDT, e.g., as described in connection with FIG. 8. In one configuration, the message from the UE may include a third indication for MO-SDT. In another configuration, the message from the UE may be received in random access resources associated with MO-SDT, e.g., as described in connection with FIG. 8.

In some aspects, the network node may include a CU-CP, and, as shown in FIG. 10, the method of MT-SDT may further include step 1002. At 1002, the CU-CP may receive, from a centralized unit user plane (CU-UP), a downlink data notification that indicates a downlink data amount for the UE. The reception may be performed, e.g., by the MT-SDT generating component 199. The CU-CP may send the paging message including the first indication of the MT-SDT based on the downlink data amount for the UE indicated by the CU-UP being less than an MT-SDT threshold. In one configuration, the method of MT-SDT may further include step 1004. In 1004, the CU-CP may receive the MT-SDT threshold from an AMF. For example, as shown in FIG. 6, the MT-SDT threshold may be transmitted from the AMF 612 to the CU-CP 608 via an NGAP message. The MT-SDT threshold may be for a PDU session, a QoS flow, or a data radio bearer.

In some aspects, the network node may include a CU-UP, and, as shown in FIG. 10, the method of MT-SDT may further include step 1006. At 1006, the CU-UP may send to the CU-CP a downlink data notification that indicates a downlink data amount for the UE. The notification may be sent, e.g., by the MT-SDT generating component 199. For example, as shown in FIG. 6, the CU-UP 606 may send a DL data notification to the CU-CP 608.

In some aspects, the network node may be a primary node for dual connectivity with the UE, and the method of MT-SDT may further include receiving an activity notification from a secondary node for the UE, and the primary node may send the paging message for the UE in response to the activity notification. In one configuration, the network node may be a secondary node for dual connectivity with the UE, and the method of MT-SDT may further include sending an activity notification to a primary node for the UE, and the primary node may send the paging message for the UE in response to the activity notification. As shown in FIG. 7A, the activity notification, received by the primary node 702 from the secondary node 704, may indicate an amount of downlink data for the UE on one or more secondary node terminated bearers.

In the scenarios the network node is a primary node for dual connectivity with the UE, the method of MT-SDT may further comprise sending an MT-SDT threshold to a secondary node for the UE; and receiving an MT-SDT indication from the secondary node. The primary node may send the paging message for the UE in response to the MT-SDT indication. In the scenarios the network node is a secondary node for dual connectivity with the UE, the method of MT-SDT may further include receiving an MT-SDT threshold from a primary node for the UE; and sending an MT-SDT indication to the primary node in response to having downlink data for the UE that is less than the MT-SDT threshold. For example, as shown in FIG. 7B, the primary node primary node 702 may send to a secondary node secondary node 704 an MT-SDT threshold during secondary node addition/modification, and the secondary node 704 may send an MT-SDT indication (indicating whether to perform MT-SDT) to the primary node 702 based on the MT-SDT threshold.

In some aspects, the network node may include an anchor node. The anchor node may send the paging message to a serving node for UE. In this scenario, the method of MT-SDT may further include receiving, from the serving node, a request to retrieve a context for the UE that includes at least one of a second indication for the MT-SDT or MT-SDT assistance information. The anchor node may forward the data for the UE to the serving node in a UE context response in response to receiving the request.

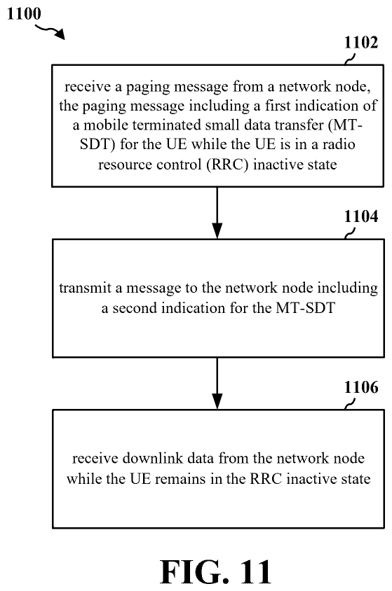

FIG. 11 is a flowchart 1100 illustrating a method of wireless communication accordance with various aspects of the present disclosure. The method may be performed by a user equipment (UE). The UE may be the UE 104, 350, 402, 502, 602, 802, or the apparatus 1304 in the hardware implementation of FIG. 13. The method provides signaling that helps to enable MT-SDT for a UE, which may improve the efficiency with which data may be transferred from a network to a UE in an RRC idle or RRC inactive state.

As shown in FIG. 11, at 1102, the UE may receive a paging message from a network node. The network node may be the base station 102 or a component of a base station, in the access network of FIG. 1 or the network entity 1302 in the hardware implementation of FIG. 13. The paging message may include a first indication of an MT-SDT for the UE while the UE is in an RRC idle or RRC inactive state. The reception may be performed, e.g., by the MT-SDT component 198.

At 1104, the UE may transmit a message to the network node including a second indication for the MT-SDT. At 1106, the UE may receive downlink data from the network node while the UE remains in the RRC idle or RRC inactive state. The transmission may be performed, e.g., by the MT-SDT component 198.

In one configuration, the second indication may include one or more of: an MT-SDT flag, a resume cause that indicates the MT-SDT, MT-SDT assistance information, or a logical channel identifier (ID) associated with the MT-SDT. In one configuration, the message from the UE comprises an RRC resume request message. In one configuration, the message from the UE comprises an uplink medium access control-control element (MAC-CE). For example, as shown in FIG. 5, the message from the UE 502 may include an RRC resume request message or a UL MAC CE message.

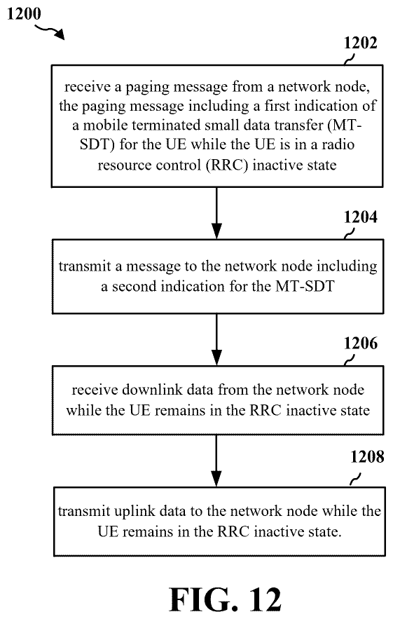

FIG. 12 is a flowchart 1200 illustrating methods of wireless communication in accordance with various aspects of the present disclosure. The method may be performed by a user equipment (UE). The UE may be the UE 104, 350, 402, 502, 602, 802, or the apparatus 1304 in the hardware implementation of FIG. 13. The method provides signaling that helps to enable MT-SDT for a UE, which may improve the efficiency with which data may be transferred from a network to a UE in an RRC idle or RRC inactive state.

As shown in FIG. 12, at 1202, the UE may receive a paging message from a network node, the paging message including a first indication of a MT-SDT for the UE while the UE is in an RRC idle or RRC inactive state. The reception may be performed, e.g., by the MT-SDT component 198. FIGS. 4, 5, 6, and 8 illustrate various examples of a UE receiving a paging message indicating MT-SDT.

At 1204, the UE may transmit a message to the network node including a second indication for the MT-SDT. The transmission may be performed, e.g., by the MT-SDT component 198. FIGS. 5, 6, and 8 illustrate various examples of a UE transmitting a message to the network for MT-SDT.

At 1206, the UE may receive downlink data from the network node while the UE remains in the RRC idle or RRC inactive state. FIGS. 5, 6, and 8 illustrate various examples of a UE receiving MT-SDT.

At 1208, the UE may transmit uplink data to the network node while the UE remains in the RRC idle or RRC inactive state. In one configuration, the message from the UE may further include a third indication for MO-SDT. In another configuration, the message may be received in random access resources associated with MO-SDT. FIG. 8 illustrates an example of a UE transmitting MO-SDT in connection with MT-SDT.

FIG. 13 is a diagram 1300 illustrating an example of a hardware implementation for an apparatus 1304. The apparatus 1304 may be a UE, a component of a UE, or may implement UE functionality. In some aspects, the apparatus 1304 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see 350 of FIG. 3) and include the additional modules of the apparatus 1304.

As discussed supra, the MT-SDT component 198 is configured to transmit a message to the network node including a second indication for the MT-SDT; and receive downlink data from the network node while the UE remains in the RRC idle or RRC inactive state. The MT-SDT component 198 may be further configured to perform any of the aspects described in connection with the flowchart in FIG. 11 or 12, and/or performed by the UE in any of FIG. 4, 5, 6, or 8. The MT-SDT receiving component 198 may be within the cellular baseband processor 1324, the application processor 1306, or both the cellular baseband processor 1324 and the application processor 1306. The MT-SDT component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving a paging message from a network node, means for transmitting a message to the network node including a second indication for the MT-SDT, and means for receiving downlink data from the network node while the UE remains in the RRC idle or RRC inactive state. The apparatus may further include means to perform any of the aspects described in connection with the flowchart in FIG. 11 or 12, and/or performed by the UE in any of FIG. 4, 5, 6, or 8. The means may be performed by the MT-SDT component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

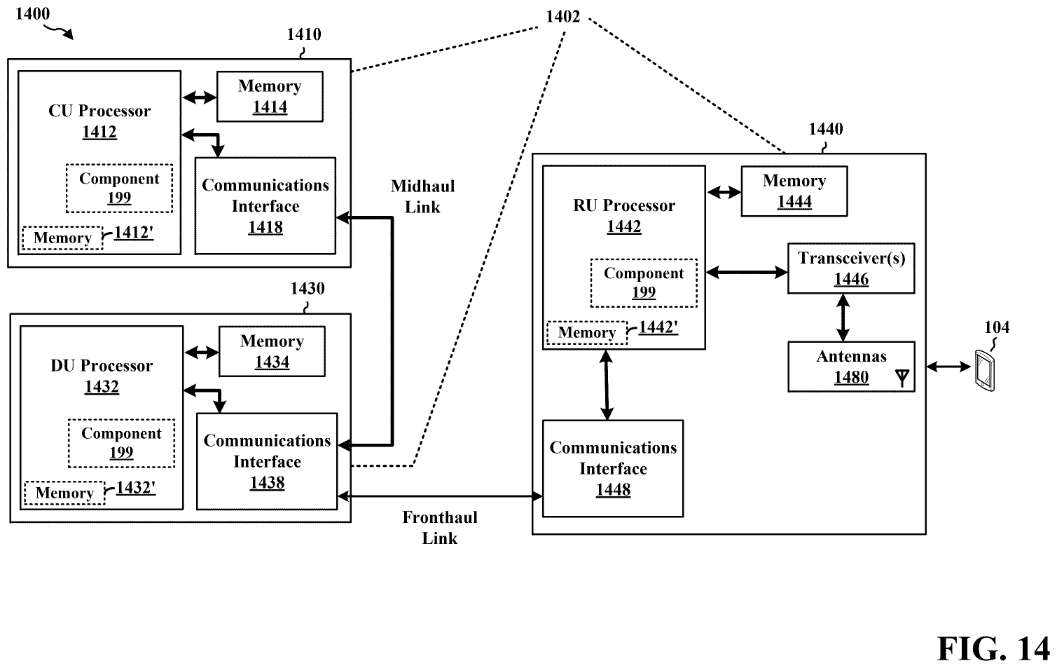

FIG. 14 is a diagram 1400 illustrating an example of a hardware implementation for a network entity 1402. The network entity 1402 may be a BS, a component of a BS, or may implement BS functionality. The network entity 1402 may include at least one of a CU 1410, a DU 1430, or an RU 1440. For example, depending on the layer functionality handled by the component 199, the network entity 1402 may include the CU 1410; both the CU 1410 and the DU 1430; each of the CU 1410, the DU 1430, and the RU 1440; the DU 1430; both the DU 1430 and the RU 1440; or the RU 1440. The CU 1410 may include a CU processor 1412. The CU processor 1412 may include on-chip memory 1412′. In some aspects, the CU 1410 may further include additional memory modules 1414 and a communications interface 1418. The CU 1410 communicates with the DU 1430 through a midhaul link, such as an F1 interface. The DU 1430 may include a DU processor 1432. The DU processor 1432 may include on-chip memory 1432′. In some aspects, the DU 1430 may further include additional memory modules 1434 and a communications interface 1438. The DU 1430 communicates with the RU 1440 through a fronthaul link. The RU 1440 may include an RU processor 1442. The RU processor 1442 may include on-chip memory 1442′. In some aspects, the RU 1440 may further include additional memory modules 1444, one or more transceivers 1446, antennas 1480, and a communications interface 1448. The RU 1440 communicates with the UE 104. The on-chip memory 1412′, 1432′, 1442′ and the additional memory modules 1414, 1434, 1444 may each be considered a computer-readable medium/memory. Each computer-readable medium/memory may be non-transitory. Each of the processors 1412, 1432, 1442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MT-SDT generating component 199 may be configured to send a paging message including a first indication of a MT-SDT for a UE in an RRC idle or RRC inactive state; and send data for transfer to the UE while the UE remains in the RRC idle or RRC inactive state. The MT-SDT generating component 199 may be further configured to perform any of the aspects described in connection with the flowchart in FIG. 9 or 10, and/or performed by the network nodes in any of FIGS. 4-8. The MT-SDT generating component 199 may be within one or more processors of one or more of the CU 1410, DU 1430, and the RU 1440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1402 may include a variety of components configured for various functions. In one configuration, the network entity 1402 includes means for sending a paging message including a first indication of a mobile terminated small data transmission (MT-SDT) for a user equipment (UE) in a radio resource control (RRC) inactive state, and means for sending data for transfer to the UE while the UE remains in the RRC idle or RRC inactive state. The network entity may further include means for performing any of the aspects described in connection with the flowchart in FIG. 9 or 10, and/or performed by the network nodes in any of FIGS. 4-8. The means may be performed by the MT-SDT generating component 199 of the network entity 1402 configured to perform the functions recited by the means. As described supra, the network entity 1402 may include the TX processor 316, the RX processor 370, and the controller/processor 375. As such, in one configuration, the means may be the TX processor 316, the RX processor 370, and/or the controller/processor 375 configured to perform the functions recited by the means.

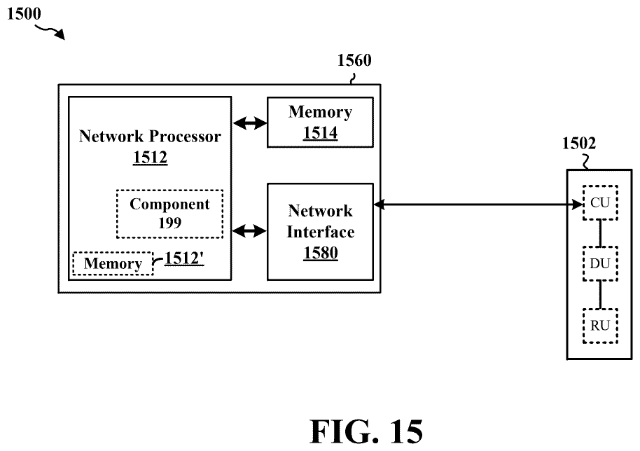

FIG. 15 is a diagram 1500 illustrating an example of a hardware implementation for a network entity 1560. In one example, the network entity 1560 may be within the core network 120. The network entity 1560 may include a network processor 1512. The network processor 1512 may include on-chip memory 1512′. In some aspects, the network entity 1560 may further include additional memory modules 1514. The network entity 1560 communicates via the network interface 1580 directly (e.g., backhaul link) or indirectly (e.g., through a RIC) with the CU 1502. The on-chip memory 1512′ and the additional memory modules 1514 may each be considered a computer-readable medium/memory. Each computer-readable medium/memory may be non-transitory. The processor 1512 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the MT-SDT generating component 199 may be configured to perform any of the aspects described in connection with the AMF or UPF in FIG. 4, 6, or 8, for example. The MT-SDT generating component 199 may be within the processor 1512. The MT-SDT generating component may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1560 may include a variety of components configured for various functions. In one configuration, the network entity 1560 includes means for sending a paging message including a first indication of a mobile terminated small data transfer (MT-SDT) for a user equipment (UE) in a radio resource control (RRC) inactive state; and means for sending data for transfer to the UE while the UE remains in the RRC idle or RRC inactive state. The means may be performed by the MT-SDT generating component 199 of the network entity 1560 configured to perform the functions recited by the means.

Aspects of the present disclosure provide for paging-triggered SDT for UEs while the UEs remain in inactive state. The disclosed methods present the enhancements for various aspects of MT-SDT, including, but not limited to, MT-SDT indication through paging, MT-SDT indication by UE, the NG-RAN determination process on whether to page UE for MT-SDT, MT-SDT with dual connectivity, MT-SDT indication in Retrieve UE Context Request, and the combination of MT-SDT and mobile originated small data transmission (MO-SDT). The enhanced aspects of MT-SDT are applicable to RA-SDT and CG-SDT as the UL response, and support MT-SDT procedure for initial DL data reception and subsequent UL/DL data transmission in the RRC idle or RRC inactive state. By providing data transmission for UEs in Idle or inactive state, power consumption, latency and system overhead may beneficially be reduced.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network node. The method comprises sending a paging message including a first indication of a mobile terminated small data transmission (MT-SDT) for a user equipment (UE) in a radio resource control (RRC) inactive state; and sending data for transfer to the UE while the UE remains in the RRC inactive state.

Aspect 2 is the method of aspect 1, wherein the network node comprises a centralized unit control plane (CU-CP) and the paging message including the first indication of the MT-SDT is comprised in an F1 application protocol (F1AP) message between the CU-CP and a distributed unit (DU).

Aspect 3 is the method of aspect 1, wherein the network node comprises a distributed unit (DU) and the paging message including the first indication of the MT-SDT is comprised in a Uu paging message between the DU and the UE.

Aspect 4 is the method of aspect 1, wherein the network node comprises an access and mobility management function (AMF) and the paging message including the first indication of the MT-SDT is comprised in an NG application protocol (NGAP) message between the AMF and a centralized unit control plane (CU-CP).

Aspect 5 is the method of aspect 1, wherein the method further comprises receiving a message from the UE including a second indication for the MT-SDT, wherein the data is transmitted to the UE in response to the message including the second indication.

Aspect 6 is the method any of aspect 5, wherein the second indication includes one or more of: an MT-SDT flag, a resume cause that indicates the MT-SDT, MT-SDT assistance information, or a logical channel identifier (ID) associated with the MT-SDT.

Aspect 7 is the method of aspect 5, wherein the message from the UE comprises an RRC resume request message.

Aspect 8 is the method of aspect 5, wherein the message from the UE comprises an uplink medium access control-control element (MAC-CE).

Aspect 9 is the method of aspect 5, wherein the message from the UE further comprises a third indication for mobile originated small data transmission (MO-SDT), and the method further comprises: receiving uplink data from the UE while the UE remains in the RRC inactive state.

Aspect 10 is the method of aspect 5, wherein the message is received in random access resources associated with mobile originated small data transmission (MO-SDT), and the method further comprises: receiving uplink data from the UE while the UE remains in the RRC inactive state.

Aspect 11 is the method of aspect 1, wherein the network node comprises a centralized unit control plane (CU-CP), and the method further comprises: receiving, from a centralized unit user plane (CU-UP), a downlink data notification that indicates a downlink data amount for the UE, wherein the CU-CP sends the paging message including the first indication of the MT-SDT based on the downlink data amount for the UE indicated by the CU-UP being less than an MT-SDT threshold.

Aspect 12 is the method of aspect 11, wherein the method further comprises: receiving the MT-SDT threshold from an access and mobility management function (AMF).

Aspect 13 is the method of any one of aspects 11 and 12, wherein the MT-SDT threshold is for a protocol data unit (PDU) session, a quality of service (QoS) flow, or a data radio bearer.

Aspect 14 is the method of aspect 1, wherein the network node comprises a centralized unit user plane (CU-UP), and the method further comprises: sending, to a centralized unit control plane (CU-CP), a downlink data notification that indicates a downlink data amount for the UE.

Aspect 15 is the method of aspect 1, wherein the network node comprises an access and mobility management function (AMF), and the method further comprises: sending an MT-SDT threshold to a centralized unit control plane (CU-CP).

Aspect 16 is the method of aspect 1, wherein the network node is a primary node for dual connectivity with the UE, and the method further comprises: receiving an activity notification from a secondary node for the UE that indicates an amount of downlink data for the UE on one or more secondary node terminated bearers, wherein the primary node sends the paging message for the UE in response to the activity notification.

Aspect 17 is the method of aspect 1, wherein the network node is a secondary node for dual connectivity with the UE, and the method further comprises: sending an activity notification to a primary node for the UE that indicates an amount of downlink data for the UE on one or more secondary node terminated bearers, wherein the primary node sends the paging message for the UE in response to the activity notification.

Aspect 18 is the method of aspect 1, wherein the network node is a primary node for dual connectivity with the UE, and the method further comprises: sending an MT-SDT threshold to a secondary node for the UE; and receiving an MT-SDT indication from the secondary node, wherein the primary node sends the paging message for the UE in response to the MT-SDT indication.

Aspect 19 is the method of aspect 1, wherein the network node is a secondary node for dual connectivity with the UE, and the method further comprises: receiving an MT-SDT threshold from a primary node for the UE; and sending an MT-SDT indication to the primary node in response to having downlink data for the UE that is less than the MT-SDT threshold.

Aspect 20 is the method of aspect 1, wherein the network node comprises an anchor node that sends the paging message to a serving node for the UE, and the method further comprises: receiving, from the serving node, a request to retrieve a context for the UE that includes at least one of a second indication for the MT-SDT or MT-SDT assistance information, wherein the anchor node forwards the data for the UE to the serving node in a UE context response in response to receiving the request.

Aspect 21 is an apparatus comprising means for performing the method of any of aspects 1-20.

Aspect 22 is an apparatus comprising a memory; and at least one processor coupled to the memory and, based at least in part on information stored in the memory, the at least one processor is configured to perform the method of any of aspects 1-20.

In aspect 23, the apparatus of aspects 21 or 22 further includes at least one transceiver.

Aspect 24 is a non-transitory computer-readable medium storing computer executable code at a network node, the code, when executed by a processor causes the processor to perform the method of any of aspects 1-20.

Aspect 25 is a method of wireless communication at a UE, comprising: receiving a paging message from a network node, the paging message including a first indication of a MT-SDT for the UE while the UE is in an RRC inactive state; transmitting a message to the network node including a second indication for the MT-SDT; and receiving downlink data from the network node while the UE remains in the RRC inactive state.

In aspect 26, the method of aspect 25, further includes that the second indication includes one or more of: an MT-SDT flag, a resume cause that indicates the MT-SDT, MT-SDT assistance information, or a logical channel ID associated with the MT-SDT.

In aspect 27, the method of aspect 25 or 26 further includes that the message from the UE comprises an RRC resume request message or an uplink MAC-CE.

In aspect 28, the method of any of aspects 25-27 further includes that the message from the UE further comprises a third indication for MO-SDT, the method further comprising: transmitting uplink data to the network node while the UE remains in the RRC inactive state.

In aspect 29, the method of any of aspects 25-27 further includes that the message is received in random access resources associated with MO-SDT, the method further comprising: transmitting uplink data to the network node while the UE remains in the RRC inactive state.

Aspect 30 is an apparatus comprising means for performing the method of any of aspects 25-29.

Aspect 31 is an apparatus comprising a memory; and at least one processor coupled to the memory and, based at least in part on information stored in the memory, the at least one processor is configured to perform the method of any of aspects 25-29.

In aspect 32, the apparatus of aspects 30 or 31 further includes at least one transceiver.

Aspect 33 is a non-transitory computer-readable medium storing computer executable code at a network node, the code, when executed by a processor causes the processor to perform the method of any of aspects 25-29.

What is claimed is:

1. An apparatus for wireless communication at a network node, comprising:
a memory; and
at least one processor coupled to the memory and, based at least in part on information stored in the memory, the at least one processor is configured to:
send a paging message including a first indication of a mobile terminated small data transmission (MT-SDT) for a user equipment (UE) in a radio resource control (RRC) inactive state; and
send data for transfer to the UE while the UE remains in the RRC inactive state.

2. The apparatus of claim 1, wherein the network node comprises a centralized unit control plane (CU-CP) and the paging message including the first indication of the MT-SDT is comprised in an F1 application protocol (F1AP) message between the CU-CP and a distributed unit (DU).

3. The apparatus of claim 1, wherein the network node comprises a distributed unit (DU) and the paging message including the first indication of the MT-SDT is comprised in a Uu paging message between the DU and the UE.

4. The apparatus of claim 1, wherein the network node comprises an access and mobility management function (AMF) and the paging message including the first indication of the MT-SDT is comprised in an NG application protocol (NGAP) message between the AMF and a centralized unit control plane (CU-CP).

5. The apparatus of claim 1, wherein the at least one processor is further configured to:
receive a message from the UE including a second indication for the MT-SDT, wherein the data is transmitted to the UE in response to the message including the second indication.

6. The apparatus of claim 5, wherein the second indication includes one or more of:
an MT-SDT flag,
a resume cause that indicates the MT-SDT, MT-SDT assistance information, or
a logical channel identifier (ID) associated with the MT-SDT.

7. The apparatus of claim 5, wherein the message from the UE comprises an RRC resume request message.

8. The apparatus of claim 5, wherein the message from the UE comprises an uplink medium access control-control element (MAC-CE).

9. The apparatus of claim 5, wherein the message from the UE further comprises a third indication for mobile originated small data transmission (MO-SDT), the at least one processor being further configured to:
receive uplink data from the UE while the UE remains in the RRC inactive state.

10. The apparatus of claim 5, wherein the message is received in random access resources associated with mobile originated small data transmission (MO-SDT), the at least one processor being further configured to:
receive uplink data from the UE while the UE remains in the RRC inactive state.

11. The apparatus of claim 1, wherein the network node comprises a centralized unit control plane (CU-CP), the at least one processor being further configured to:
receive, from a centralized unit user plane (CU-UP), a downlink data notification that indicates a downlink data amount for the UE, wherein the CU-CP sends the paging message including the first indication of the MT-SDT based on the downlink data amount for the UE indicated by the CU-UP being less than an MT-SDT threshold.

12. The apparatus of claim 11, wherein the at least one processor is further configured to:
receive the MT-SDT threshold from an access and mobility management function (AMF).

13. The apparatus of claim 12, wherein the MT-SDT threshold is for a protocol data unit (PDU) session, a quality of service (QoS) flow, or a data radio bearer.

14. The apparatus of claim 1, wherein the network node comprises a centralized unit user plane (CU-UP), the at least one processor being further configured to:
send, to a centralized unit control plane (CU-CP), a downlink data notification that indicates a downlink data amount for the UE.

15. The apparatus of claim 1, wherein the network node comprises an access and mobility management function (AMF), the at least one processor being further configured to:
send an MT-SDT threshold to a centralized unit control plane (CU-CP).

16. The apparatus of claim 1, wherein the network node is a primary node for dual connectivity with the UE, the at least one processor being further configured to:
receive an activity notification from a secondary node for the UE that indicates an amount of downlink data for the UE on one or more secondary node terminated bearers, wherein the primary node sends the paging message for the UE in response to the activity notification.

17. The apparatus of claim 1, wherein the network node is a secondary node for dual connectivity with the UE, the at least one processor being further configured to:
send an activity notification to a primary node for the UE that indicates an amount of downlink data for the UE on one or more secondary node terminated bearers, wherein the primary node sends the paging message for the UE in response to the activity notification.

18. The apparatus of claim 1, wherein the network node is a primary node for dual connectivity with the UE, the at least one processor being further configured to:
send an MT-SDT threshold to a secondary node for the UE; and
receive an MT-SDT indication from the secondary node, wherein the primary node sends the paging message for the UE in response to the MT-SDT indication.

19. The apparatus of claim 1, wherein the network node is a secondary node for dual connectivity with the UE, the at least one processor being further configured to:
receive an MT-SDT threshold from a primary node for the UE; and
send an MT-SDT indication to the primary node in response to having downlink data for the UE that is less than the MT-SDT threshold.

20. The apparatus of claim 1, wherein the network node comprises an anchor node that sends the paging message to a serving node for the UE, the at least one processor being further configured to:
receive, from the serving node, a request to retrieve a context for the UE that includes at least one of a second indication for the MT-SDT or MT-SDT assistance information, wherein the anchor node forwards the data for the UE to the serving node in a UE context response in response to receiving the request.

21. The apparatus of claim 1, further comprising:
at least one transceiver coupled to the at least one processor and configured to send the paging message.

22. An apparatus for wireless communication at a user equipment (UE), comprising:
a memory; and
at least one processor coupled to the memory and, based at least in part on information stored in the memory, the at least one processor is configured to:
receive a paging message from a network node, the paging message including a first indication of a mobile terminated small data transmission (MT-SDT) for the UE while the UE is in a radio resource control (RRC) inactive state;
transmit a message to the network node including a second indication for the MT-SDT; and
receive downlink data from the network node while the UE remains in the RRC inactive state.

23. The apparatus of claim 22, wherein the second indication includes one or more of:
an MT-SDT flag,
a resume cause that indicates the MT-SDT,
MT-SDT assistance information, or
a logical channel identifier (ID) associated with the MT-SDT.

24. The apparatus of claim 22, wherein the message from the UE comprises an RRC resume request message.

25. The apparatus of claim 22, wherein the message from the UE comprises an uplink medium access control-control element (MAC-CE).

26. The apparatus of claim 22, wherein the message from the UE further comprises a third indication for mobile originated small data transmission (MO-SDT), the at least one processor being further configured to:
transmit uplink data to the network node while the UE remains in the RRC inactive state.

27. The apparatus of claim 22, wherein the message is received in random access resources associated with mobile originated small data transmission (MO-SDT), the at least one processor being further configured to:
transmit uplink data to the network node while the UE remains in the RRC inactive state.

28. The apparatus of claim 22, further comprising:
at least one transceiver coupled to the at least one processor and configured to receive the paging message.

29. A method of wireless communication at a network node, comprising:
sending a paging message including a first indication of a mobile terminated small data transfer (MT-SDT) for a user equipment (UE) in a radio resource control (RRC) inactive state; and
sending data for transfer to the UE while the UE remains in the RRC inactive state.

30. A method of wireless communication at a user equipment (UE), comprising:
receiving a paging message from a network node, the paging message including a first indication of a mobile terminated small data transfer (MT-SDT) for the UE while the UE is in a radio resource control (RRC) inactive state;
transmitting a message to the network node including a second indication for the MT-SDT; and
receiving downlink data from the network node while the UE remains in the RRC inactive state.
